(19) United States
(12) Patent Application Publication
(10) Pub. No.: US 2026/0104102 A1
(43) Pub. Date: Apr. 16, 2026

(54) SWITCHING DEVICE WITH PUSH BUTTON AND WATER OUTLET DEVICE

(71) Applicant: XIAMEN MIQI TECHNOLOGY CO., LTD, XIAMEN (CN)

(72) Inventors: JIE CHEN, XIAMEN (CN); CHUNHUI LIN, XIAMEN (CN)

(21) Appl. No.: 19/246,729

(22) Filed: Jun. 24, 2025

(30) Foreign Application Priority Data
Oct. 15, 2024 (CN) 202411438776.1
May 6, 2025 (CN) 202520872532.8

(51) Int. Cl. F16K 31/00; E03C 1/04; E03C 1/02

(52) U.S. Cl. CPC F16K 31/003; E03C 1/0408; E03C 2001/026

(57) ABSTRACT

A witching structure with a push button and a water outlet device are provided. The witching structure includes a main body, central bolt assemblies, and a pushing piece. The main body defines a water inlet channel, a first water guide cavity, and a second water guide cavity. The first water guide cavity defines a first water outlet and a second water outlet. The first water guide cavity is communicated with a first water outlet channel through the first water outlet. The second water guide cavity defines a third water outlet and a fourth water outlet. The second water guide cavity is communicated with the second water outlet through a second water outlet channel. The central bolt assemblies are respectively disposed in the first water guide cavity and the second water guide cavity. The pushing piece is movable linearly to switch a water flow between different water outlet channels.

### TECHNICAL FIELD

The present disclosure relates to a technical field of bathroom equipment, and in particular to a switching device with a push button and a water outlet device.

### BACKGROUND

In a design of modern bathroom products, functional diversification and operational convenience of water outlet devices have become important research and development directions. Especially in equipment such as handheld showers and overhead showers, users have an increasing demand for different water outlet effects. These different water outlet effects are commonly realized by configuring switching structures to switch between different water flow paths of the handheld showers and the overhead showers, thereby meeting personalized use needs of the users.

However, there are many defects in conventional switching structures. For example, a conventional ballpoint pen-type switching structure mainly relies on ratchet teeth to switch between water flow paths thereof. Although the conventional ballpoint pen-type switching structure has a compact structure, a complex design thereof leads to high manufacturing costs. Further, the conventional ballpoint pen-type switching structure is easy to get stuck after long-term use. In addition, a dial-type switching structure switches water flow paths thereof by rotating a dial thereof in a circumferential direction. Although a rotation operation is intuitive, it requires greater operating force and a user experience is not good. More importantly, showers and spray guns on the market are independent products, and functions of the two are difficult to integrate. Even if some products try to integrate a function of the spray guns into the showers, water outlet modes are relatively simple, which are unable to meet actual needs of the users for diverse water outlet modes.

### SUMMARY

To solve problems in the prior art, the present disclosure provides a witching structure with a push button and a water outlet device.

The present disclosure provides the witching structure with the push button. The witching structure with the push button comprises a main body, central bolt assemblies, and a pushing piece. The main body defines a water inlet channel therein, a first water guide cavity, and a second water guide cavity. A water flow in the water inlet channel is capable of flowing to the first water guide cavity. The first water guide cavity defines a first water outlet and a second water outlet. The first water outlet is communicated with a first water outlet channel defined in the main body, and the second water outlet is communicated with a second water outlet channel defined in the main body. The central bolt assemblies comprise a first central bolt assembly and a second central bolt assembly. The first central bolt assembly is movable and is disposed in the first water guide cavity, and the first central bolt assembly is movable to open the first water outlet or the second water outlet. A water flow in the second water outlet channel is capable of flowing to the second water guide cavity. The second water guide cavity defines a third water outlet and a fourth water outlet. The third water outlet is communicated with a third water outlet channel defined in the main body, and the fourth water outlet is communicated with a second water outlet channel defined in the main body. The second central bolt assembly is movable and is disposed in the second water guide cavity, and the second central bolt assembly is movable to open the third water outlet or the fourth water outlet. The pushing piece is configured to move linearly relative to the main body, and the pushing piece moves to control movement of the first central bolt assembly and movement of the second central bolt assembly.

The present disclosure further provides the water outlet device. The water outlet device comprises the switching device with the push button mentioned above.

The water outlet device realizes switching of various water spray effects and is suitable for bathroom products such as shower heads and overhead showers. By integrating the switching structure with the push button into the water outlet device, an integrated design of diversified water outlet functions is realized.

The switching structure with the push button and the water outlet device disclosed in the present disclosure have following characteristics.

First, the pushing piece capable of moving linearly realizes switching of water flow paths, simplifies complexity with respect to a conventional ballpoint pen-type switching structure or a dial-type switching structure, and reduces manufacturing cost and assembly difficulty. Secondly, a user only needs to push the push button to complete the switching of different water outlet modes, which requires less operating force and provides a better user experience. Thirdly, by optimizing a design of the two central bolt assemblies and the pushing piece, the switching of the water flow paths is realized, and the switching device with the push button has diverse water outlet functions of a spray gun, so that the water outlet device has functions of both the shower head and the spray gun, which improves the practicality of the water outlet device. Finally, by designing each of the central bolt assemblies to comprise a sealing ring, sealing gaskets and two sealing pieces, a sealing effect of the water outlet device during a water flow switching process is ensured to prevent water leakage.

To sum up, the present disclosure provides the switching device with the push button and the water outlet device by optimizing a structural design and operating logic, which solves problems of complex structure, inconvenient operation and single function of conventional switching structures in the prior art, and has significant technical progress and market application value.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of a switching device with a push button according to one embodiment of the present disclosure.

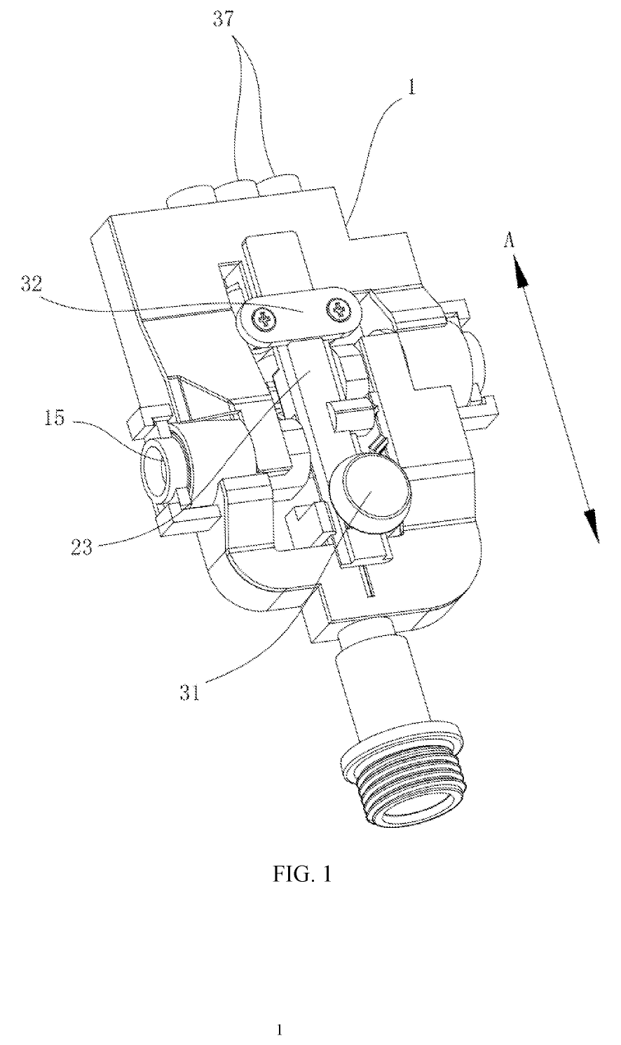

FIG. 2 is a schematic diagram of a main body according to one embodiment of the present disclosure.

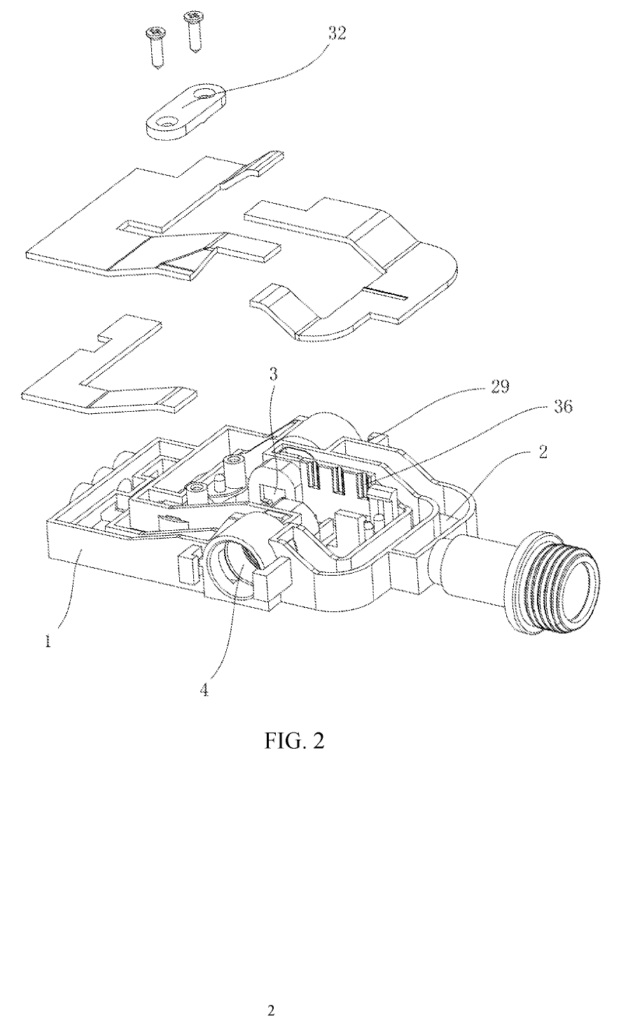

FIG. 3 is an exploded schematic diagram of one of central bolt assemblies according to one embodiment of the present disclosure.

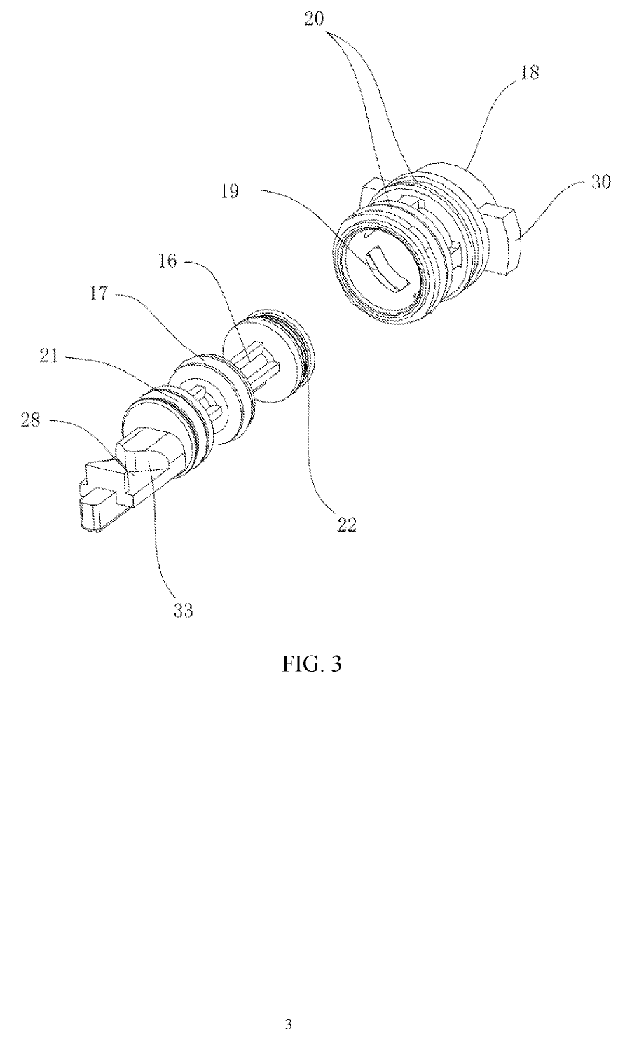

FIG. 4 is an exploded schematic diagram of a pushing piece according to one embodiment of the present disclosure.

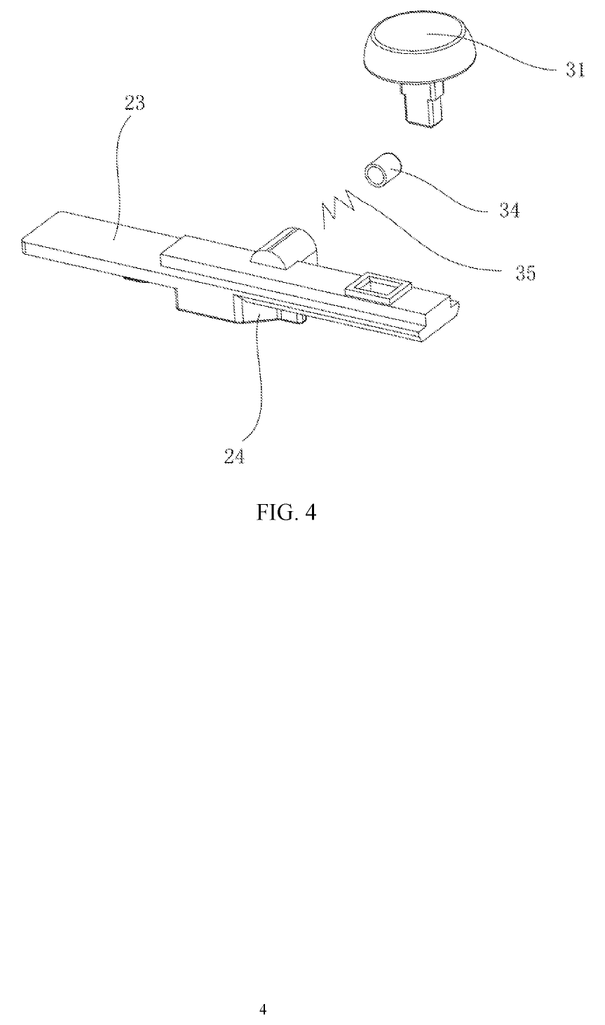

FIG. 5 is a schematic diagram of the pushing piece according to one embodiment of the present disclosure.

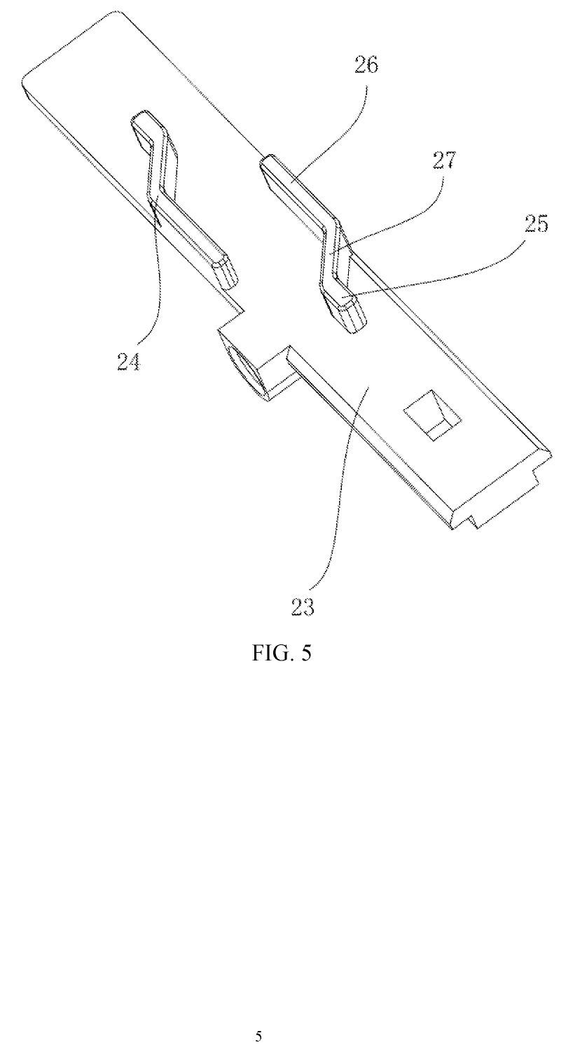

FIG. 6 is a schematic diagram of the switching device with the push button according to one embodiment of the present disclosure when water is flowing through a first water outlet channel.

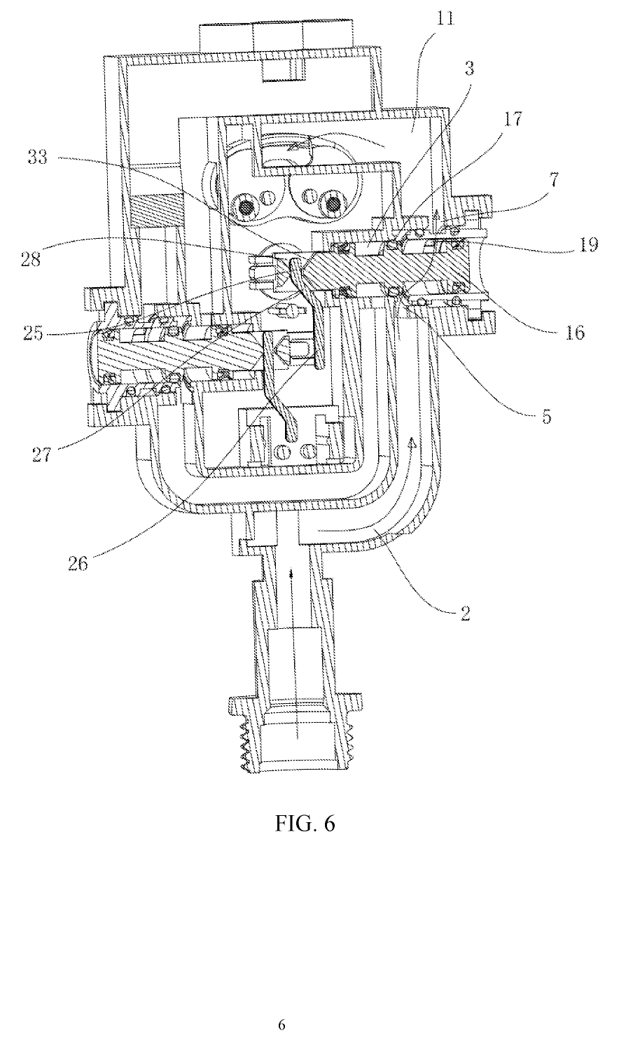

FIG. 7 is a schematic diagram of the switching device with the push button according to one embodiment of the present disclosure when the water is flowing through a second water outlet channel and a third water outlet channel.

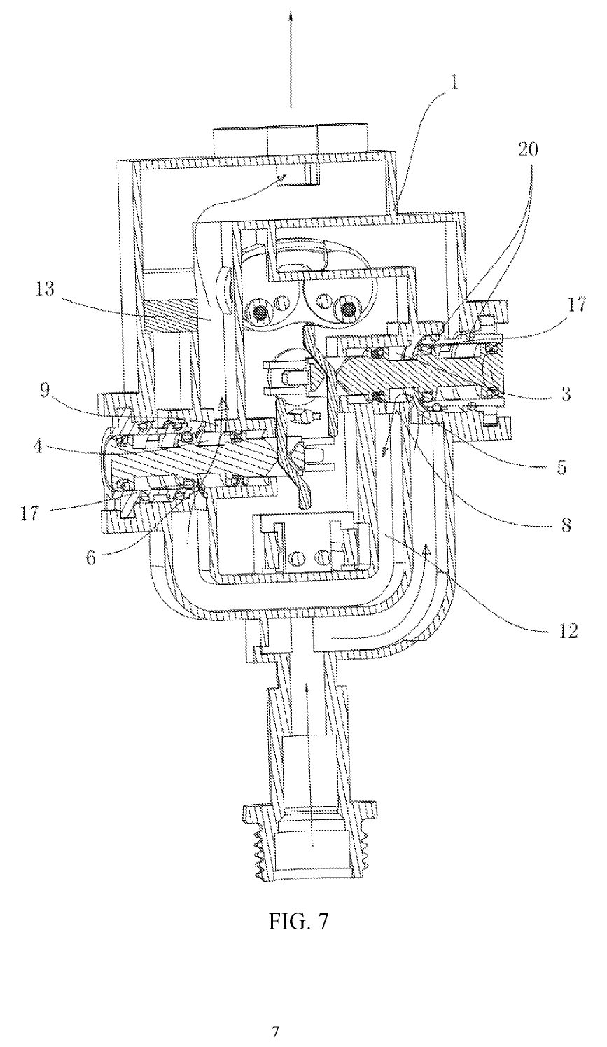

FIG. 8 is a schematic diagram of the switching device with the push button according to one embodiment of the present disclosure when the water is flowing through the second water outlet channel and a fourth water outlet channel.

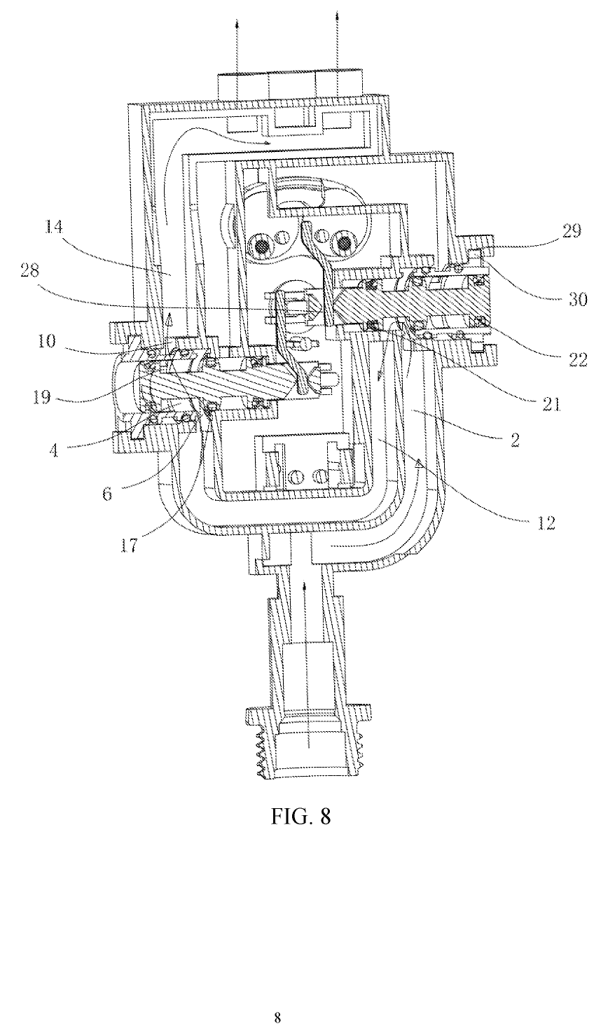

### DETAILED DESCRIPTION

As shown in the drawings, the present disclosure provides a switching device with a push button. The switching device comprises a main body 1, two central bolt assemblies 15 and a pushing piece 23. The main body 1 defines a water inlet channel 2 therein, a first water guide cavity 3, and a second water guide cavity 4. The main body 1 serves as a basic structure of the switching device, and water flow channels and cavities are designed therein to achieve water flow guiding and switching. The water inlet channel 2 is defined in the main body 1 and is configured to introduce an external water source. A water flow in the water inlet channel 2 is capable of flowing to the first water guide cavity 3 through a first water inlet 5. The first water guide cavity 3 comprises two water outlets, that is, the first water outlet 7 and a second water outlet 8. The first water outlet 7 is communicated with a first water outlet channel 11, and the second water outlet 8 is communicated with a second water outlet channel 12. In one embodiment, these structures are located on the upper portion of the main body, and the first water outlet channel 11 extends to a lower portion of the main body 1. A water outlet panel (not shown in the drawings) may be mounted to the lower portion of the main body to form a water outlet device of the present disclosure, and the water outlet device is a shower head. The water outlet panel enables various water spray modes, which are switched by rotation.

The two central bolt assemblies 15 comprise a first central bolt assembly 15 and a second central bolt assembly 15. The water flow distribution in the first water guide cavity 3 is controlled by the first central bolt assembly 15. Each of the central bolt assemblies 15 comprises a central bolt 16, a sealing ring 17, a bushing 18, a water passing port 19, sealing gaskets 20, a first sealing piece 21, and a second sealing piece 22,. The central bolt 16 of the first central bolt assembly is capable of moving linearly (in the left-right direction) in the bushing 18 of the first central bolt assembly 15, thereby realizing opening of the first water outlet 7 or the second water outlet 8.

In the first water guide cavity 3, the first water inlet 5 is located in a middle portion of the first water guide cavity, and the first water outlet 7 and the second water outlet 8 are respectively located on two sides of the first water inlet 5. The sealing ring 17 sleeved on the central bolt 16 of the first central bolt assembly 15 is configured to change a position thereof along with the movement of the central bolt 16 of the first central bolt assembly 15. When the sealing ring 17 of the first central bolt assembly 15 moves to a position of the first water outlet 7, the first water outlet 7 is closed, and the water flow is only allowed to flow out from the second water outlet 8. On the contrary, when the sealing ring 17 of the first central bolt assembly 15 moves to a position of the second water outlet 8, the second water outlet 8 is closed, and the water flow is only allowed to flow out from the first water outlet 7. Such design ensures accuracy and sealing during a water flow switching process. In addition, a water passing port 19 penetrating through each bushing 18 is defined on the side wall of each bushing 18, and the water passing port 19 of each bushing 18 is matched with the first water outlet 7. The sealing gaskets 20 of each of the central bolt assemblies 15 are disposed on two sides of each water passing port 19, so that each bushing forms a sealed connection with a corresponding water guide cavity, thereby further enhancing a sealing effect in the water flow switching process.

The first sealing piece 21 of each of the central bolt assemblies 15 is closer to a middle portion of the main body 1 than the second sealing piece 22 of each of the central bolt assemblies 15. The first sealing piece 21 of the first central bolt assembly 15 is matched with an inner peripheral wall of the first water guide cavity 3. The first sealing piece 21 of the first central bolt assembly 15 is located on an inner side of the second water outlet 8, so as to prevent the water flow in the first water guide cavity 3 from leakage. The first sealing piece 21 of the second central bolt assembly 15 is matched with an inner peripheral wall of the second water guide cavity 4. Each second sealing piece 22 is matched with an inner peripheral wall of a corresponding bushing 18 and is located on an outer side of a corresponding water passing port 19 to ensure that the water flow is only allowed to flow out through the corresponding water passing port 19.

A design of the second water guide cavity 4 is similar to that of the first water guide cavity 3, but functions of the second water guide cavity 4 are slightly different. The second water guide cavity 4 is communicated with the second water outlet channel 12 through the second water inlet 6. The second water guide cavity 4 comprises two water outlets, which are respectively a third water outlet 9 and a fourth water outlet 10. The third water outlet 9 is communicated with the third water outlet channel 13. The fourth water outlet 10 is communicated with the fourth water outlet channel 14. The water flow distribution in the second water guide cavity 4 is controlled by the second central bolt assembly 15. The central bolt 16 of the second central bolt assembly 15 is capable of moving linearly in the bushing 18 of the second central bolt assembly 15 to realize opening of the third water outlet 9 or the fourth water outlet 10. By arrangement of the second water guide cavity 4, after the water flow flows through the first water guide cavity 3, different water outlet channels are selected, and diversified water outlet effects are realized.

In one optional embodiment, three nozzles are disposed at the upper portion of the main body (while the water inlet is defined in the lower portion of the main body). A middle nozzle (i.e., a second nozzle) is communicated with the third water outlet channel, and a first nozzle and a third nozzle are communicated with the fourth water outlet channel. Thus, the main body has two different water outlet modes. When the switching device with the push button is mounted to the shower head, the three nozzles 37 form two different water spray patterns, and water flow switching between the two water spray patterns and the water outlet panel is realized by the pushing piece, so that the shower head has various water spray modes, switching between the water spray modes is easy, and an overall structure of the shower head is simple.

The pushing piece 23 is one of key components of the present disclosure and is configured to move linearly relative to the main body 1. The pushing piece 23 comprises the push button 31 and two guide rods 24. The push button 31 is configured to push the pushing piece 23 to move up and down relative to the main body. Further, at least one limiting piece 32 is disposed on the main body, and the at least one limiting piece 32 is configured to prevent the pushing piece 23 from separating from the main body. More specifically, the two guide rods 24 are prevented from separating from respective guide groove 28. When the pushing piece 23 moves, each of the guide rods 24 cooperates with a corresponding guide groove 28, so as to control the movement of the central bolt 16 of each of the central bolt assemblies 15. Each of the guide rods 24 cooperates with the guide groove 28 on a corresponding central bolt 16, and the two central bolts 16 are staggered from top to bottom in the main body 1.

The two guide rods 24 comprise two first straight sections 25, two second straight sections 26 and two inclined sections 27. Each of the inclined sections 27 is disposed between a corresponding one of the first straight sections 25 and a corresponding one of the second straight sections 26. The two first straight sections 25 and the two second straight sections 26 are parallel to a moving direction A (an up-down direction shown in the drawings) of the pushing piece 23. Each of the inclined sections 27 forms an included angle with the moving direction of the pushing piece 23. The two guide rods 24 comprise a first guide rod 24 and a second guide rod 24.

When a first straight section 25 of the first guide rod 24 abuts against the guide groove 28 of the first central bolt assembly 15 and a second straight section 26 of the second guide rod 24 abuts against the guide groove 28 of the second central bolt assembly, each central bolt 16 does not move. When a second straight section 26 of the first guide rod 24 abuts against the guide groove 28 of the first central bolt assembly 15 and a first straight section 25 of the second guide rod 24 abuts against the guide groove 28 of the second central bolt assembly, each central bolt 16 does not move. When the pushing piece 23 moves to cause an inclined section 27 of the first guide rod 24 to abut against the guide groove 28 of the first central bolt assembly 15, the first guide rod 24 drives the central bolt 16 of the first central bolt assembly 16 to move in the first water guide cavity 3. When the pushing piece 23 moves to cause an inclined section 27 of the second guide rod 24 to abut against the guide groove 28 of the second central bolt assembly 15, the second guide rod 24 drives the central bolt 16 of the second central bolt assembly 15 to move in the second water guide cavity 4. Such design ensures that an overall structure of the witching structure with the push button is as small as possible, and the movement of each central bolt 16 is capable of accurately controlling a flow direction of the water flow, avoiding a situation where the push button drives the movement of two central bolts 16 at the same time, thereby preventing water leakage.

Two clamping grooves 29 are respectively disposed on two sides of the main body 1. The clamping grooves 29 are respectively matched with the first water guide cavity 3 and the second water guide cavity 4. Lugs 30 matching a corresponding one of the clamping grooves 29 are disposed on an outer periphery of each bushing 18. The lugs 30 of each bushing 18 are rotated to be connected to the corresponding one of the clamping grooves 29, so that each bushing 18 is relatively fixed and matched with the main body 1. This fixing method not only facilitates assembly, but also enhances the stability of the switching device.

One end of the central bolt of the first central bolt assembly 15 close to the middle portion of the main body 1 extends out of the first water guide cavity 3. One end of the central bolt of the second central bolt assembly close to the middle portion of the main body 1 extends out of the second water guide cavity 4. The one end of the central bolt of each of the central bolt assemblies 15 is placed in the middle portion of the main body 1. The guide groove 28 is defined at the one end of the central bolt of each of the central bolt assemblies 15. Along the moving direction of the pushing piece 23, each guide groove 28 is narrow in a middle portion and wide at two ends. Guide slopes 33 are formed at two sides of each guide groove 28; and a length of each of the first straight sections 25 is less than a length of each of the second straight sections 26. Therefore, movement of each central bolt is accurately controlled. Therefore, the two central bolts 16 of the two central bolt assemblies 15 are unable to move at the same time, realizing accurately switching of water flow paths.

Furthermore, a groove (not marked in the drawings) is defined on one side of the pushing piece, a marble 34 and a spring 35 are disposed in the groove, and gear slots 36 are defined on the main body. Each time a switch is completed, the marble is embedded into a corresponding one of the gear slots 36, and the sound generated may inform the user that the switch is completed. The two central bolts 16 realize the switching of three water flow paths, so three gear slots are provided.

A working principle of the present disclosure is as follows.

When the user pushes the pushing piece 23 (specifically, the push button 31 on the pushing piece 23 is pushed), the pushing piece 23 moves linearly to drive each of the guide rods 24 to move in the corresponding guide groove 28. When the inclined section 27 of the first guide rod 24 abuts against the guide groove 28 of the first central bolt assembly, the movement of the pushing piece 23 drives the central bolt 16 of the first central bolt assembly to move linearly in the first water guide cavity 3. The movement of the central bolt 16 of the first central bolt assembly changes the position of the sealing ring 17 of the first central bolt assembly, thereby the first water outlet 7 or the second water outlet 8 is selectively opened. When the first water outlet 7 is opened, the water flow in the first water guide cavity 3 flows out of the first water outlet 7 then flows into the first water outlet channel 11 and flows out through the water outlet panel. When the second water outlet 8 is opened, the water flow in the first water guide cavity 3 flows out from the second water outlet 8, and then enters the second water guide cavity 4 along the second water outlet channel 12. Then, the pushing piece 23 continues to be pushed to move, so that the central bolt 16 of the second central bolt assembly 15 in the second water guide cavity 4 is driven to move, thereby realizing the selective opening of the third water outlet 9 or the fourth water outlet 10. When the third water outlet 9 is opened, the water flow flowing out of the second water guide cavity 4 flows into the third water outlet channel 13 and then is sprayed out from the second nozzle. When the fourth water outlet is opened, the water flow flowing out of the second water guide cavity 4 flows into the fourth water outlet channel 14 and then is sprayed out from the first nozzle and the third nozzle. The design of the present disclosure enables the water flow to flow to different water outlet channels according to the needs of the user, thereby switching various water spray effects.

The application scenarios of the present disclosure are mainly concentrated in the field of bathroom equipment. For example, the water outlet device is the shower head, the overhead shower, or other products. By integrating the switching device with the push button into the water outlet device, an integrated design of diversified water outlet functions is realized. For example, when the water outlet device is the shower head, the user is able to switch between different water spray effects by pushing the push button, such as switching between a rain mode, a massage mode and a spray mode. When the water outlet device is the overhead shower, the user is able to switch the water spray effects between concentrated water flow mode and dispersed water flow mode through the switching device with the push button to meet different usage requirements. In addition, the present disclosure is further able to be applied to a shower product with diversified functions of a spray gun, and the diversified functions of the spray gun are realized through switching between the water outlet channels. For example, different nozzles with different water spray effects are disposed on the upper portion of the shower head, and the nozzles are not limited to performing the diversified functions of the spray gun, and the nozzles may further present a sector-shaped water splash effect, so that the shower head not only integrates the function of the shower head, but also has a variety of water spray effects of the spray gun.

The switching device with the push button and the water outlet device disclosed in the present disclosure have following characteristics.

First, the pushing piece capable of moving linearly realizes switching of the water flow paths, simplifies complexity with respect to a conventional ballpoint pen-type switching structure or a dial-type switching structure, and reduces manufacturing cost and assembly difficulty. Secondly, the user only needs to push the push button to complete the switching of different water spray effects, which requires less operating force and provides a better user experience. Thirdly, by optimizing the design of the two central bolt assemblies and the pushing piece, the switching of the water flow paths is realized, and the switching device with the push button has diverse water outlet functions of a spray gun, so that the water outlet device has functions of both the shower head and the spray gun, which improves the practicality of the water outlet device. Finally, by designing each of the central bolt assemblies 15 to comprise the sealing ring 17, the sealing gaskets 20 and two sealing pieces, the sealing effect of the water outlet device during the water flow switching process is ensured to prevent water leakage.

To sum up, the present disclosure provides the switching device with the push button and the water outlet device by optimizing a structural design and operating logic, which solves problems of complex structure, inconvenient operation and single function of conventional switching structures in the prior art, and has significant technical progress and market application value.

What is claimed is:

1. A switching device with a push button, comprising:
a main body;
central bolt assemblies; and
a pushing piece;
wherein the main body defines a water inlet channel therein, a first water guide cavity, and a second water guide cavity;
wherein a water flow in the water inlet channel is capable of flowing to the first water guide cavity, the first water guide cavity defines a first water outlet and a second water outlet, the first water outlet is communicated with a first water outlet channel defined in the main body, and the second water outlet is communicated with a second water outlet channel defined in the main body;
wherein the central bolt assemblies comprise a first central bolt assembly and a second central bolt assembly;
wherein the first central bolt assembly is movable and is disposed in the first water guide cavity, and the first central bolt assembly is movable to open the first water outlet or the second water outlet;
wherein the water flow flowing to the second water outlet channel is capable of flowing to the second water guide cavity, the second water guide cavity defines a third water outlet and a fourth water outlet, the third water outlet is communicated with a third water outlet channel defined in the main body, and the fourth water outlet is communicated with a second water outlet channel defined in the main body;
wherein the second central bolt assembly is movable and is disposed in the second water guide cavity, and the second central bolt assembly is movable to open the third water outlet or the fourth water outlet;
wherein the pushing piece is configured to move linearly relative to the main body, and the pushing piece moves to control movement of the first central bolt assembly and movement of the second central bolt assembly.

2. The switching device with the push button according to claim 1, wherein the first water guide cavity and the second water guide cavity are disposed on two sides of the main body, the first water guide cavity defines a first water inlet, the first water inlet is configured to communicate the first water guide cavity with the water inlet channel, the first water outlet and the second water outlet are disposed on two sides of the first water inlet;
wherein the second water guide cavity defines a second water inlet, the second water inlet is configured to communicate the second water guide cavity with the second water outlet channel, and the third water outlet and the fourth water outlet are disposed on two sides of the second water inlet.

3. The switching device with the push button according to claim 2, wherein each of the central bolt assemblies comprises a central bolt that is movable, the central bolt of each of the central bolt assemblies is sleeved with a sealing ring, the sealing ring of the first central bolt assembly is movable to the two sides of the first water inlet, and the sealing ring of the second central bolt assembly is movable to the two sides of the second water inlet.

4. The switching device with the push button according to claim 3, wherein each of the central bolt assemblies further comprises a bushing, the bushing of the first central bolt assembly is disposed in the first water guide cavity, the bushing of the second central bolt assembly is disposed in the second water guide cavity, each central bolt is movable in a corresponding bushing, each bushing defines a water passing port penetrating through a side wall thereof, the water passing port on the bushing of the first central bolt assembly is matched with the first water outlet, the water passing port on the bushing of the second central bolt assembly is matched with the fourth water outlet, and sealing gaskets are respectively sleeved on two sides of each bushing;
wherein each of the central bolt assemblies comprises a first sealing piece and a second sealing piece, the first sealing piece of each of the central bolt assemblies is closer to a middle portion of the main body than the second sealing piece of each of the central bolt assemblies, the first sealing piece of the first central bolt assembly is matched with an inner peripheral wall of the first water guide cavity, the first sealing piece of the second central bolt assembly is matched with an inner peripheral wall of the second water guide cavity, the first sealing piece of the first central bolt assembly is disposed on an inner side of the second water outlet, the first sealing piece of the second central bolt assembly is disposed on an inner side of the third water outlet, and each second sealing piece is disposed on an outer side of a corresponding water passing port.

5. The switching device with the push button according to claim 4, wherein clamping grooves are respectively disposed on the two sides of the main body, the clamping grooves are respectively matched with the first water guide cavity and the second water guide cavity, lugs matching a corresponding one of the clamping grooves are disposed on an outer periphery of each bushing, the lugs of each bushing are rotated to be connected to the corresponding one of the clamping grooves, so that each bushing is relatively fixed and matched with the main body.

6. The switching device with the push button according to claim 4, wherein one end of the central bolt of the first central bolt assembly close to the middle portion of the main body extends out of the first water guide cavity, and one end of the central bolt of the second central bolt assembly close to the middle portion of the main body extends out of the second water guide cavity;
wherein the one end of the central bolt of each of the central bolt assemblies is placed in the middle portion of the main body, and a guide groove is defined in the one end of the central bolt of each of the central bolt assemblies;
wherein two guide rods are disposed on the pushing piece, each of the guide rods is configured to be matched with a corresponding guide groove, and when the pushing piece moves, each of the guide rods drives a corresponding central bolt to move.

7. The switching device with the push button according to claim 6, wherein the two guide rods comprise two first straight sections, two second straight sections and two inclined sections, each of the inclined sections is disposed between a corresponding one of the first straight sections and a corresponding one of the second straight sections, the two first straight sections and the two second straight sections are parallel to a moving direction of the pushing piece, and each of the inclined sections forms an included angle with the moving direction of the pushing piece;
wherein the two guide rods comprise a first guide rod and a second guide rod;
wherein when a first straight section of the first guide rod abuts against the guide groove of the first central bolt assembly and a second straight section of the second guide rod abuts against the guide groove of the second central bolt assembly, each central bolt does not move; when a second straight section of the first guide rod abuts against the guide groove of the first central bolt assembly and a first straight section of the second guide rod abuts against the guide groove of the second central bolt assembly, each central bolt does not move; when the pushing piece moves to cause an inclined section of the first guide rod to abut against the guide groove of the first central bolt assembly, the first guide rod drives the central bolt of the first central bolt assembly to move in the first water guide cavity; and when the pushing piece moves to cause an inclined section of the second guide rod to abut against the guide groove of the second central bolt assembly, the second guide rod drives the central bolt of the second central bolt assembly to move in the second water guide cavity.

8. The switching device with the push button according to claim 7, wherein the two first straight sections are disposed at two ends of the pushing piece along the moving direction, and the two second straight sections are disposed on two sides of the pushing piece;
wherein when the inclined section of the first guide rod abuts against the guide groove of the first central bolt assembly, the inclined section of the second guide rod does not abut against the guide groove of the second central bolt assembly; and when the inclined section of the second guide rod abuts against the guide groove of the second central bolt assembly, the inclined section of the first guide rod does not abut against the guide groove of the first central bolt assembly, so that two central bolt assemblies are unable to move at the same time.

9. The switching device with the push button according to claim 8, wherein along the moving direction of the pushing piece, and each guide groove is narrow in a middle portion and wide at two ends;
wherein guide slopes are formed at two sides of each guide groove, and a length of each of the first straight sections is less than a length of each of the second straight sections.

10. A water outlet device, comprising: the switching device with the push button according to claim 1.
